(19) United States
(12) Patent Application Publication
(10) Pub. No.: US 2010/0107148 A1
(43) Pub. Date: Apr. 29, 2010

(54) CHECK-STOPPING FIRMWARE IMPLEMENTED VIRTUAL COMMUNICATION CHANNELS WITHOUT DISABLING ALL FIRMWARE FUNCTIONS

(75) Inventors: DIETMAR F. DECKER, WURMBERG (DE); WALERI FOMIN, SCHOENAICH (DE); ANDREAS GERSTMEIER, UNTERSCHNEIDHEIM (DE); OTTO RUOSS, GAERTRINGEN (DE); ALEXANDRA WINTER, SCHWIEBERDINGEN (DE)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/259,898

(22) Filed: Oct. 28, 2008

(51) Int. Cl. G06F 11/20; G06F 9/44

(52) U.S. Cl. 717/168; 714/4; 714/E11.071

(57) ABSTRACT

The present invention discloses a solution for check-stopping firmware implemented virtual communication channels without disabling all firmware functions. In the solution, a virtual input/output subsystem of firmware can be selectively isolated from other portions of the firmware. This permits the virtual input/output subsystem to be disabled when severe errors occur involving virtual communication channels, without affecting other portions and functions of the firmware. Check-stopping the virtual I/O subsystem can be performed using existing hardware mechanisms for handling permanent errors including channel report words (CRW), channel control block (CHCB), and the like. The subsystem can be reactivated in response to a firmware patch which can be an automated or manual procedure.

### BACKGROUND

The present invention relates to the field of firmware and error handling and, more particularly, to check-stopping firmware implemented virtual communication channels without disabling all firmware functions.

Physical communication channels in System z sometimes experience hardware errors that cannot be repaired by recovery actions. When these types of errors occur, the channels are check-stopped in order to isolate the problem and prevent damage to the entire system. In System z, this is performed by setting a permanent error in a channel control block. These permanent errors remain in effect until troublesome hardware is fixed, after which the permanent errors are released and the disabled communication channels can again be used.

A special type of virtual communication channel is available in System z that is called Hipersockets. At present, there is no hardware based check-stop that can be applied to these virtual communication channels, since they are implemented at a layer of abstraction above the hardware layer. Occasionally, errors occur in Hipersockets Firmware, which results in a situation where it is no longer safe to use the virtual communication channels. These channels cannot currently be isolated and disabled without disabling the entire firmware (central electronic complex (CEC) firmware) in which the virtual communication channels are implemented. The CEC firmware is a critical system component which performs many other functions than just those related to the virtual communication channels. Thus, severe errors based upon the virtual communication channel can cause all CEC functions to be disabled, which adversely affects normal system operations.

### BRIEF DESCRIPTION OF THE SEVERAL VIEWS OF THE DRAWINGS

FIG. 1 is a schematic diagram illustrating a system implementing virtual communication channels able to be check-stopped without disabling all firmware functionality in accordance with an embodiment of the inventive arrangements disclosed herein.

FIG. 2 is a flowchart illustrating a method for isolating a virtual channel subsystem experiencing a severe failure within a firmware in accordance with an embodiment of the inventive arrangements disclosed herein.

FIG. 3 is a schematic diagram illustrating a firmware implementing virtual communication channels able to check-stop the virtual communication channels without disabling all firmware functions in accordance with an embodiment of the inventive arrangements disclosed herein.

### DETAILED DESCRIPTION

The present invention discloses a solution for check-stopping firmware implemented virtual communication channels without disabling all firmware functions. In the solution, a virtual input/output subsystem of firmware can be selectively isolated from other portions of the firmware. This permits the virtual input/output subsystem to be disabled when severe errors occur involving virtual communication channels, without affecting other portions and functions of the firmware. Check-stopping the virtual channel subsystem can be performed using existing mechanisms for handling and reporting permanent errors including channel control blocks, channel report words, and the like. The subsystem can be reactivated in response to a firmware patch which can be an automated or manual procedure.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

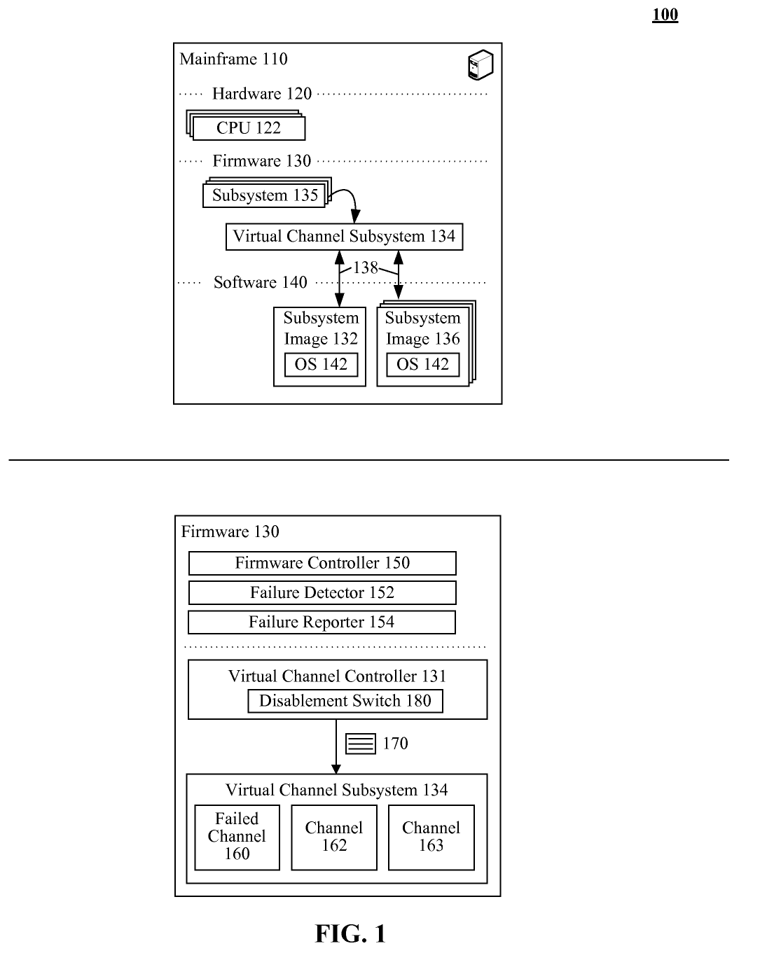

FIG. 1 is a schematic diagram illustrating a system 100 implementing virtual communication channels able to be check-stopped without disabling all firmware functionality in accordance with an embodiment of the inventive arrangements disclosed herein. In system 100, a mainframe 110 can disable virtual channel subsystem 134 in response to reoccurring and/or unrecoverable subsystem 134 malfunction. The subsystem 134 can be isolated and deactivated without affecting the rest of the firmware 130 functionality. That is subsystems 135 other than the virtual channel subsystem 134 continue to function normally. Thus, a subsystem 134 failure can be contained allowing mainframe 110 to retain stability and reliability in the presence of a critical failure.

As used herein a check-stop can be a firmware state causing the suspension and/or deactivation of one or more firmware components. The check-stop state can be triggered in response to one or more reoccurring and/or unrecoverable errors occurring within firmware 130. Reoccurring and/or unrecoverable errors can include component failures, communication channel failures, corrupted data structures, corrupted executable code, and the like. Channels 138 can be firmware implement communication channels able to act as a transport layer for one or more message passing protocols (e.g., TCP/IP).

In virtual channel subsystem 134, a set of virtual communication channels 138 within firmware 130 can facilitate message passing between subsystem images 132, 136. The virtual communication channels can have no direct linkage to hardware-level network interface adaptors, which makes detecting and correcting problems with the virtual communication channels 138 challenging. Traditionally, when errors were detected with virtual channel subsystem 134, the entire firmware 130 including all firmware subsystems were disabled. System 100 permits a disablement switch 180 to disable the virtual channel subsystem 134 without affecting other portions of the firmware 130. Images 132, 136 can be locally distributed server images executing programmatic code such as applications, operating systems 142, and the like. In one embodiment, images 132, 136 can include virtualized operating systems 142 executing within mainframe 110. In the embodiment, images 132, 136 can communicate using hardware-abstracted firmware channels 138. The images 132, 136 and their included operating systems 142 can be implemented at the software 140 level.

In mainframe 110, a virtual channel subsystem 134 can be placed into a check-stop state in response to one or more fatal errors occurring within subsystem 134 (e.g., channel failure 160). Using existing hardware mechanisms, subsystem 134 can be isolated from other firmware 130 subsystems 135 during a subsystem 134 failure. There is a check-stop state used to halt CPU 122 during hardware malfunction. The same check-stop state can be used to perform the same action on subsystem 134. That is, subsystem 134 can be selectively disabled allowing mainframe 110 components 120, 130, 140 to function normally, except for the functionality provided by 134.

Firmware controller 150 can be used to direct firmware 130 activity and manage detector 152 and reporter 154 actions. Controller 150 can permit the configuration of behavior for components 152, 154, and 131. Controller 150 can configure error threshold behavior for triggering a check-stop state. For example, if an error occurs more than three times within thirty seconds, a check-stop state can be enacted. Further, controller 150 can allow an administrative agent to manually enable or disable controller 131 by setting disablement switch 180.

Disablement switch 180 can be a stored state value used to determine the state and/or condition of subsystem 134. In one embodiment, disablement switch 180 can indicate a check-stop state for subsystem 134. For instance, disablement switch 180 set to a value of “one” can indicate subsystem 134 is deactivated. In an alternative embodiment, each channel 160-163 can be associated with an individual disablement switch 180. In the embodiment, a single failed channel 160 can be selectively deactivated without affecting the entire channel subsystem 134. Alternatively, disablement switch 180 can be one or more portions of executable code able to terminate subsystem 134 activity in response to fatal errors.

Failure detector 152 can detect failures associated with failed channels, malfunctioning channels, corrupt data structures in subsystem 134, corruption in channel controller 131, and the like. Detection of failures can be performed by detector 152 based on a checksums, verifiable hashes, system test checks, and the like. For instance, software error checking program code can be employed to determine an error event within subsystem 134. Detector 152 can determine and identify a failed channel 160 within subsystem 134 and take appropriate action. One action can include conveying a failure event and information about the failure to failure reporter 154.

Failure reporter 154 can perform data gathering and failure report generation useful in diagnosis of channel 160 error. Reporter 154 can utilize data gained from first failure data capture (FFDC), attempted recovery actions, and the like. Reporter 154 can notify system components of the failure such as operating system 142, subsystem 134, firmware controller 150, and the like. Notification can permit affected system 110 components to adjust functionality in response to the failure. Additionally, reporter 154 can generate administrative notifications permitting an administrative agent to address the failure.

Virtual channel controller 131 can be responsible for maintaining and handling subsystem 134 functionality. Controller 131 can be separate component from subsystem 134 in firmware 130 or can be present within subsystem 134. Controller 131 can convey message 170 to subsystem 134 which can force a check-stop on subsystem 134 when one or more reoccurring and/or unrecoverable errors occur within subsystem 134. Message 170 can be a check-stop directive instructing the deactivation of subsystem 134. For instance, subsystem 134 can disable all channels 160-163 upon receipt of message 170.

Once a check-stop state has been reached, firmware 130 can continue to function normally in the absence of subsystem 134 functionality. Application of a firmware patch implemented to resolve the failure can trigger subsystem 134 to be reactivated. If the applied firmware patch fails to resolve the reoccurring and/or unrecoverable failure, the firmware controller 150 will take appropriate actions. Controller 150 can reinstate the check-stop state for subsystem 134 and can force a firmware rollback, reverting the firmware 130 to the previous un-patched state.

Drawings presented herein are for illustrative purposes only and should not be construed to limit the invention in any regard. Firmware implemented virtual channels are not limited to mainframe 110 implementations and can be present within any computing device capable of executing a firmware. Components in firmware 130 can be distributed differently from drawings presented herein permitting that the functionality described is maintained.

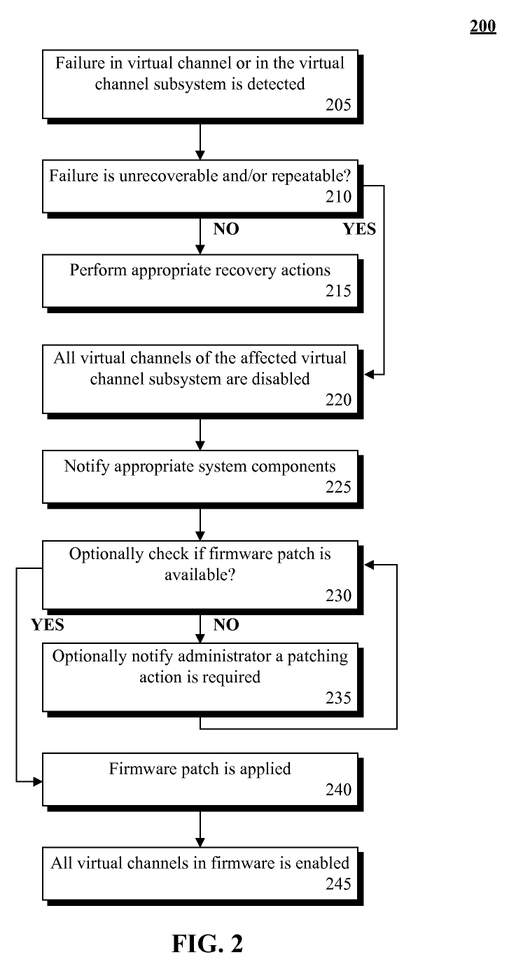

FIG. 2 is a flowchart illustrating a method 200 for isolating a virtual channel subsystem experiencing a severe failure within a firmware in accordance with an embodiment of the inventive arrangements disclosed herein. In method 200, a virtual channel subsystem can be check-stopped in response to one or more communication channel failures or subsystem failures. When a reoccurring and/or unrecoverable error occurs within the subsystem and error recovery fails, the firmware can direct the deactivation of the virtual channel subsystem. The virtual channel subsystem can be deactivated without affecting other firmware operations and functionality. The virtual channel subsystem can be reactivated when a firmware patch is applied affecting the failing subsystem component.

In step 205, a failure in the virtual channel or in the virtual channel subsystem can be detected. The virtual channel can be a communication channel (e.g., TCP/IP) emulated within firmware responsible for message passing. The failure can include corrupt subsystem data structures, malfunctioning channels, and the like. In step 210, if the failure is reoccurring and/or unrecoverable the method can proceed to step 220, else continue to step 215. In step 215, appropriate recovery actions can be performed based on the nature of the failure. Recovery actions can be an automatically performed action taken by hardware components, firmware components, software components, and the like. Alternatively, an administrator can manually execute a recovery action in response to the subsystem failure.

In step 220, all virtual channels within the firmware can be disabled to maintain system stability. In step 225, the firmware (e.g., error reporting component) can notify the appropriate system components of subsystem failure and deactivation. Notification of components can include software components such as host/guest operating systems, software I/O subsystem, and the like. In step 230, if a firmware patch is available, the method can proceed to step 240, else continue to step 235. In step 235, a system administrator can be optionally notified that a patching action is required due to subsystem failure. In step 240, a firmware patch can be applied which can be an automated patch procedure or manual patching action. In step 245, all virtual channels within firmware can be enabled in response to the patching action. The activation can be an automatic or manual procedure once the patch is applied.

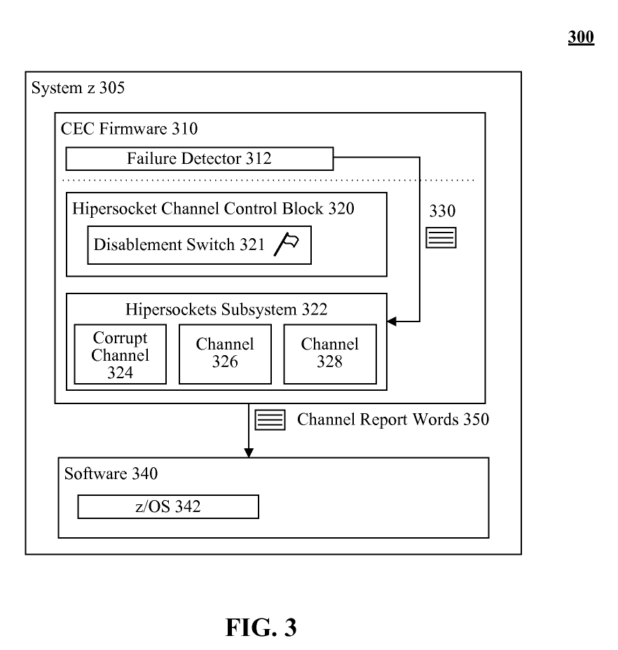

FIG. 3 is a schematic diagram illustrating a firmware 310 implementing virtual communication channels able to check-stop the virtual communication channels without disabling all firmware functions in accordance with an embodiment of the inventive arrangements disclosed herein. System 300 can be present in the context of system 100. A System z 305 executing a central electronic complex (CEC) firmware 310 can utilize disablement switch 321 to isolate subsystem 322 from other components within the firmware 310 when an reoccurring and/or unrecoverable failure occurs. That is, in the presence of multiple and unrecoverable errors, subsystem 322 can be deactivated without affecting firmware 310 functionality.

As used herein, a Hipersocket can be one or more virtual communication channels enabling the transmission of messages to and from System z 305 components. Corrupt channel 324 can be a virtual communication channel experiencing one or more failures which can generate an error message and/or action.

In CEC firmware 310, detector 312 can be a firmware component able to detect and identify one or more failures within Hipersocket channel subsystem 322. Detector 312 can detect failures associated with failed channels, malfunctioning channels, corrupt data structures in subsystem 322, and the like. Detection of failures can be performed by detector 312 based on one or more system test checks. For instance, corrupt channel 324 can be detected using a checksum identified by detector 312. In one embodiment, detector 312 can use Hipersocket channel control block 320 to perform a subsystem check-stop on subsystem 322.

Detection of corrupt channel 324 can cause the failure detector 312 to communicate a message 330 to subsystem 322 invoking a check-stop on all channels 324-328. Message 330 can be a check-stop message directing subsystem 322 to exit any currently executing code and disable channels 324-328. In one embodiment, message 330 can be an interrupt level message triggering a check-stopped state in subsystem 322.

Disablement switch 321 can be one or more stored values within control block indicating the status of block 320 and/or subsystem 322. In one embodiment, disablement switch 321 can be used to set a permanent error flag within control block 320. Disablement switch 321 can be tied to control block 320 indicating the corrupt channel(s) in subsystem 322. In another embodiment, switch 321 can denote the nature of the error in subsystem 322, type of error, channel path identifier (CHPID), affected image identifier (IID), and the like. Alternatively, the switch 321 can be used to control one instance of subsystem 322 when multiple instances of Hipersocket channel subsystem 322 are present.

When a check-stop state is initiated for Hipersocket channel subsystem 322, CEC firmware can convey an error report to software level processes. This can permit software 340 level actions to be taken in response to the check-stop state. Actions can include notifying locally executing server images of the check-stopped state, notifying administrators of subsystem failure, and the like. For instance, channel report words 350 can be communicated to an executing instance of z/OS 342 or other operating system (zLinux, z/VM, z/VSE, etc.).

Drawings presented herein are for illustrative purposes only and should not be construed to limit the invention in any regard. Component 312 within firmware 310 can be implemented within System z 305 hardware and/or software. Implementation details for System z 305 components 320-350 can vary from drawings presented herein. Although System z 305 is presented, other systems implementing Hipersocket functionality are contemplated.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for handling reoccurring and/or unrecoverable errors comprising:
detecting an occurrence of a severe problem related to a set of at least one virtual communication channels, wherein the virtual communication channel is implemented within firmware as a virtual input/output subsystem, wherein the severe problem is one that is unable to be resolved by a standard recovery action and that indicates a problem exists in the virtual input/output subsystem firmware itself;
check-stopping the set of virtual communication channels, which prevents communications involving the set of virtual communication channels; and
isolating the virtual input/output subsystem from a remainder of the firmware, which permits the firmware other than the virtual input/output subsystem to continue to operate despite the check-stopping of the set of virtual communication channels.

2. The method of claim 1, further comprising:
toggling a disablement switch from an enabled state to a disabled state responsive to the check-stopping, wherein when the disablement switch is in the disabled state, all interfaces between other portions of the firmware and the virtual input/output subsystem are disabled, wherein when the interfaces are disabled function calls to the virtual input/output subsystem will return immediately without any code of the virtual input/output subsystem executing.

3. The method of claim 1, further comprising:
requiring a patch of the firmware that fixes the severe problem as a prerequisite to re-enabling the set of virtual communication channels, wherein the firmware in which the virtual communication channels are implemented is central electronic complex (CEC) firmware, and wherein the isolating of the virtual input/output subsystem from a remainder of the central electronic complex (CEC) firmware permits functions of the central electronic complex (CEC) other than those for the virtual input/output subsystem to continue to operate despite the check-stopping.

4. The method of claim 1, wherein a severe problem is a problem specific to firmware encoded instructions having no direct linkage to a hardware-level network interface adaptor malfunction.

5. A computer program product for handling reoccurring and/or unrecoverable errors comprising a computer readable storage medium comprising hardware having computer usable program code embodied therewith, the computer program product comprising:
computer usable program code configured to detect an occurrence of a severe problem related to a set of at least one virtual communication channels, wherein the virtual communication channel is implemented within firmware as a virtual input/output subsystem, wherein the severe problem is one that is unable to be resolved by a standard recovery action and that indicates a problem exists in the virtual input/output subsystem firmware itself;
computer usable program code configured to check-stop the set of virtual communication channels, which prevents communications involving the set of virtual communication channels; and
computer usable program code configured to isolate the virtual input/output subsystem from a remainder of the firmware, which permits the firmware other than the virtual input/output subsystem to continue to operate despite the check-stopping of the set of virtual communication channels.

6. The computer program product of claim 5, further comprising:
computer usable program code configured to toggle a disablement switch from an enabled state to a disabled state responsive to the check-stopping, wherein when the disablement switch is in the disabled state, all interfaces between other portions of the firmware and the virtual input/output subsystem are disabled, wherein when the interfaces are disabled function calls to the virtual input/output subsystem will return immediately without any code of the virtual input/output subsystem executing.

7. The computer program product of claim 5, further comprising:
computer usable program code configured to require a patch of the firmware that fixes the severe problem as a prerequisite to re-enabling the set of virtual communication channels, wherein the firmware in which the virtual communication channels are implemented is central electronic complex (CEC) firmware, and wherein the isolating of the virtual input/output subsystem from a remainder of the central electronic complex (CEC) firmware permits functions of the central electronic complex (CEC) other than those for the virtual input/output subsystem to continue to operate despite the check-stopping.

8. The computer program product of claim 5, wherein a severe problem is a problem specific to firmware encoded instructions having no direct linkage to a hardware-level network interface adaptor malfunction.
